(19) United States
(12) Patent Application Publication
(10) Pub. No.: US 2026/0295816 A1
(43) Pub. Date: Oct. 1, 2026

(54) SYSTEM FOR SINGULATING FABRIC LAYERS

(71) Applicant: Silana GmbH, Wien (AT)

(72) Inventors: Michael MAYR, Wien (AT); Michael HOFMANNRICHTER, Baden (AT); Anton WOHLGEMUTH, Stainz (AT); Urs HUNZIKER, Meilen (CH)

(73) Assignee: Silana GmbH, Wien (AT)

(21) Appl. No.: 19/489,862

(22) PCT Filed: Jun. 6, 2024
(86) PCT No.: PCT/EP2024/065633

§ 371 Date: Dec. 3, 2025

(30) Foreign Application Priority Data
Jun. 7, 2023 (DE) 10 2023 114 951.2

(51) Int. Cl. B25J 9/16; B25J 13/08; B25J 15/00; B25J 15/06

(52) U.S. Cl. CPC B25J 9/1612; B25J 9/1679; B25J 9/1697; B25J 13/081; B25J 15/0071; B25J 15/0616

(57) ABSTRACT

The present disclosure relates to a system for handling and processing fabric layers. The system comprises a handling robot with an effector for handling fabric layers, wherein the effector comprises a handling mechanism. The handling mechanism comprises an effector contour, wherein the fabric layer can be fastened within the effector contour, wherein the effector contour is smaller than an outer contour of the fabric layer. The handling mechanism is configured to singulate and receive at least one fabric layer individually from a fabric layer stack, to deposit at least one singulated fabric layer in a flat manner on a work surface and to span the fabric layer within the effector contour in a fold-free manner. Furthermore, the system comprises a monitoring device, which is configured to monitor the singulation of the at least one fabric layer.

This application is a national US phase of PCT/EP2024/065633 which claims the benefit of the filing date of the German Patent Application No. 10 2023 114 951.2 filed 7 Jun. 2023, the disclosure of which is hereby incorporated herein by reference.

### TECHNICAL FIELD

The present disclosure relates to a system and a method for handling and processing fabric layers with a handling mechanism and a monitoring device for monitoring the singulation of a fabric layer from a fabric layer stack.

### BACKGROUND OF THE DISCLOSURE

In the technical field of textile processing, it is an aim to increase the degree of automation in order to reduce personnel costs and correspondingly production costs.

A textile processing system, which is designed, for example, for automated sewing, requires a handling mechanism in order to singulate the fabric from a stack and to feed it to a sewing system (or sewing machine) in sufficient proximity after manipulation. For this purpose, robots with an effector are used, on which corresponding gripping mechanisms for gripping a textile piece are arranged. However, fabric parts which represent an item of clothing have different sizes and can have different properties (thickness, air permeability, stiffness, etc.) both among one another and within the same piece.

In order to grip these thin and easily deformable textile pieces, high demands are placed on the handling of the textile pieces during textile processing. For the manipulation of textile pieces, different types of effectors with corresponding grippers are known in robotics. These grippers can be configured as contour-adaptive grippers and, for example, enable an adaptable gripping around of different types of textile pieces. Furthermore, different vacuum gripping systems are known, which can fix and handle the textile piece by means of suction cups.

Especially when singulating fabric layers from a fabric layer stack, it is necessary to ensure that, for example, only one upper fabric layer of a specific number of fabric layers is gripped. Furthermore, it is necessary that the fabric layers are gripped in a specific alignment and, for example, in a fold-free manner. If the predetermined number of fabric layers or also the predetermined alignment and characteristic of the fabric layers does not coincide, a high reject is generated with a high degree of automation.

### SUMMARY OF THE DISCLOSURE

There may be a neee to increase the quality of the processing of a plurality of fabric layers.

This need is met with a system and a method for handling and processing fabric layers according to the subject matters of the independent patent claims.

According to a first aspect of the present disclosure, a system for handling and processing fabric layers is provided. The system comprises a handling robot with an effector for handling fabric layers.

The effector comprises a handling mechanism which is configured to receive and deposit at least one fabric layer, wherein the handling mechanism comprises an effector contour. The fabric layer can be fastened within the effector contour, wherein the effector contour is smaller than an outer contour of the fabric layer. In other words, the fabric layer is larger than the effector contour and projects beyond the effector contour.

The handling mechanism is configured to singulate and receive at least one fabric layer individually from a fabric layer stack, wherein the handling mechanism is further configured to deposit at least one singulated fabric layer in a flat manner on a work surface of a work table and to span the fabric layer within the effector contour in a fold-free manner.

Furthermore, the system comprises a monitoring device, which is configured to monitor the singulation of the at least one fabric layer from the fabric layer stack. In other words, the monitoring device can monitor the process of the singulation of the at least one fabric layer and thus ensure whether, for example, the predetermined number, i.e. one or a specific number of fabric layers are handled.

A method for handling and processing fabric layers is described with a further aspect of the present disclosure. The method comprises receiving and depositing at least one fabric layer by means of a handling mechanism of an effector of a handling robot, wherein the handling mechanism comprises an effector contour and wherein the fabric layer can be fastened within the effector contour. The effector contour is smaller than an outer contour of the fabric layer, wherein the handling mechanism is configured to singulate and receive at least one fabric layer individually from a fabric layer stack and to deposit at least one singulated fabric layer in a flat manner on a work surface of a work table.

According to the method, the fabric layer is spanned within the effector contour in a fold-free manner. Furthermore, the method comprises monitoring the singulation of the at least one fabric layer from the fabric layer stack by means of a monitoring device.

The handling robot comprises the effector, to which the corresponding handling mechanism is, in particular exchangeably, attached. The handling robot is fastened with a stationary robot base to the floor or to the work table in order to introduce corresponding forces into the corresponding system. Alternatively, the handling robot can also be configured such that the robot base is designed to be movable along the floor. A robot arm can be arranged between the effector and the robot base, which robot arm comprises, for example, one or more joints in order thus to control the effector into a desired position.

The handling robot is a programmable multi-purpose handling device for moving material, workpieces, tools or special devices. In particular, the handling robot is configured to handle or manipulate the fabric layers and to move and position them accordingly. In other words, the handling robot enables a machine-controlled position change possibility in more than one axis and/or along a translational position change of the fabric layers.

The term fabric layer denotes the possible textiles or textile parts of a textile product, in particular an item of clothing. The term fabric layer includes different knitted forms, in particular woven and non-woven fabrics. The left/left side of a fabric layer denotes the inner side (i.e. the fabric underside, fabric inner side or the “not beautiful side” of a fabric layer). In the case of an item of clothing, the left side corresponds to the non-visible side of the fabric layer. The “beautiful side” of a fabric or fabric layer is used as the right/right side of a fabric layer (e.g. the fabric upper side, visible side, fabric outer side). In the case of an item of clothing, the right side corresponds to the visible side of the fabric or the fabric layer (e.g. the outer side of a T-shirt). Furthermore, a fabric part can consist of a plurality of fabric layers. For example, a fabric part (such as, for example, an item of clothing) can be folded multiple times and can rest on a worktable as a fabric layer stack with a plurality of fabric layers. Alternatively, the fabric layers can each represent separate fabric parts which form a fabric layer stack one above the other.

The controllable handling mechanism is arranged at the effector. The handling mechanism conveys one or more fabric layers. The fabric layers can be placed loosely one on top of the other and can be gripped as a stack (for example by means of negative pressure or by means of a mechanical gripper of the handling mechanism), or the fabric layers are fastened to one another, for example temporarily. The handling mechanism can convey the fabric layers to a joining unit. The effector or the handling mechanism can adapt to the contour of the fabric layers, for example by fixing points of the handling mechanism being adjustable to which the fabric layer is fixed. For example, the fixing elements described below can be arranged for this purpose, in which the individual fixing points are formed. The handling mechanism covers in particular the outline-relevant points of a contour of the fabric layer, wherein an edge of the fabric layers preferably remains free as a joining region and is not covered by the handling mechanism. The region of the fabric layers which is covered by the effector or the handling mechanism for fixing the fabric layers is referred to below as the effector contour.

The effector thus forms an end part of the handling robot with, for example, grippers as a handling mechanism which grip and manipulate a fabric layer (for example a planar unprocessed fabric layer or an entire item of clothing as a fabric layer) or a fabric layer stack which consists of fabric layers which are fastened by a fixing mechanism.

The joining unit is configured to process the joining regions of a fabric layer and/or to connect at least two fabric layers. The joining unit can be a sewing machine, a welding machine, a stitching machine, a crocheting machine, an automatic gluing machine or further automatic connecting machines for fabric layers. The joining unit can connect two fabric layers to one another, for example, so that a seam (fabric seam or weld seam, etc.) is produced. The seam describes, for example, the connection of two fabric layers by means of a thread or yarn, wherein at least the one material substantially represents a fabric, a non-woven fabric or a woven fabric.

According to the approach of the present disclosure, in particular a monitoring device is provided which monitors a singulation of the at least one fabric layer or the plurality of fabric layers from the fabric layer stack. It can thus be ensured that an exact orientation of the fabric layers and an exact depositing of the fabric layers is enabled for a later further processing, for example at the joining unit. The monitoring device can in particular also recognize the fold-free state of the fabric layers when this is picked up by the handling mechanism within the effector contour. As explained in the exemplary embodiments, the monitoring device can recognize the correct singulation of the desired fabric layers by the handling mechanism, for example by means of a weight measurement, by means of an optical measurement and/or by means of the measurement of an electromagnetic field. The degree of automation in the textile processing can thus be increased since, for example, no personal monitoring of the handling of the fabric layers is necessary, but rather can be automated by means of the monitoring device. Furthermore, the quality of the processing of the fabric layers is also increased since errors during the singulation of the fabric layers are automatically recognized by means of the monitoring device.

According to a further exemplary embodiment, the monitoring device comprises an optical sensor, in particular a monitoring camera. The optical sensor is configured to detect a singulated fabric layer, which is received by the handling mechanism. By means of an optical sensor, e.g. a camera and a suitable subsequent evaluation, both the receiving of the fabric layers and the fold-free positioning after the depositing can be ensured.

According to a further exemplary embodiment, the monitoring device comprises a weight sensor, wherein the weight sensor is arranged at the effector such that a weight of the fabric layer received by the handling mechanism is measurable. Additionally or alternatively, the weight sensor is installed in the worktable and configured such that a weight change of the fabric layer stack is measurable before and after the singulation of a fabric layer. In particular by means of an electronic weighing and the embedding of the result in the control, it is determined that only one fabric layer or a desired plurality of fabric layers is detected. The fabric layer stack and/or the weight increase at the effector can be weighed before and after the singulation. By comparison before and after the singulation, it can be concluded how many fabric layers have been removed from the fabric layer stack by the effector.

According to a further exemplary embodiment, the monitoring device comprises a touch sensor and/or a distance sensor to determine the presence of a singulated fabric layer at the handling mechanism. By means of the touch sensor, distance sensor or proximity sensor, the presence of a fabric layer which is held by the handling mechanism and, for example, also the thickness of the fabric layers or the total thickness of the fabric layers at the effector can be monitored. A touch sensor may, for example, denote a pressure sensor which, on account of the penetration depth of a held fabric layer or fabric layers with a specific pressure, can detect how many fabric layers are held. A distance sensor or a distance sensor can, for example, measure the thickness of the fabric layers. The distance sensor can, for example, be an ultrasound sensor or an optical sensor. The pressure sensor can, for example, comprise an extendable piston which measures the resistance when pressed into the fabric layers. It can thus, for example, be ensured that only one fabric layer or a desired plurality of fabric layers has been received. Such a device can also be used to decide when a gripping operation is to be started and when it is finished.

According to a further exemplary embodiment, the handling mechanism comprises a suction device which is configured to singulate and receive a fabric layer from the fabric layer stack by means of negative pressure. The monitoring device comprises in particular a vacuum sensor which is configured to measure an air flow of the suction device, wherein the air flow is indicative of whether the suction device holds a fabric layer, whether multiple fabric layers are held or whether no fabric layer is received.

The suction device comprises, for example, at least one suction unit, wherein the suction device is configured to suck air from at least one fabric layer to be held by means of the suction unit in such a way that a fabric layer or fabric layers lying one on top of the other can be fixed to the suction device. Since the fabric layers are air-permeable to a certain degree on account of their material properties, one, two or more fabric layers can be fastened in a fabric layer stack by means of suction with a correspondingly set suction power. The suction device comprises, for example, a vacuum pump which can be arranged spaced apart from the effector, for example at the work table. One or more suction units, such as suction cups, for example, can be fastened to the effector as part of the handling mechanism. Furthermore, the suction device with the suction units can also form parts of the handling mechanism in order to align and convey the fixed fabric layers. In an exemplary embodiment, the suction device also forms parts of the handling mechanism for handling the fabric layers.

For example, the suction device can additionally form a pull-on region (German: Anzugbereich) in the worktable in order to hold a fabric layer lying on the worktable from below (according to the principle of a vacuum spanning table) and to hold the upper fabric from above with the effector. An improved relative alignment between the first fabric layer and the second fabric layer can thus be achieved, since the fabric layer lying on the worktable does not slip and remains fixed.

The vacuum sensor can measure the air flow (in particular the volume flow) which is drawn in by the suction units through the held fabric layers, in particular as a function of the power consumption of the vacuum pump. On the basis of these parameters, it can be determined whether one or more fabric layers are held. For example, if a plurality of fabric layers are held, the volume flow which is drawn in with a corresponding power consumption of the vacuum pump is reduced. If the input air flow is reduced when receiving a piece of fabric in a vacuum suction unit, this can be detected as an indication of a successful reception by means of pressure monitoring on the vacuum line or flow monitoring of the sucking air flow. Flow monitoring can also detect the incorrect receiving of two pieces of fabric in the case of textiles which are permeable to some extent. In particular, it can be discriminated, for example, that the volume flow of a vacuum gripper must lie between a minimum value and a maximum value.

According to a further exemplary embodiment, the suction device forms a suction surface on which one of the fabric layers or the fabric layer stack can be placed. The suction surface comprises a plurality of suction openings, in particular more than 9, more than 15, more than 22 and/or more than 30 suction openings. In the case of a handling mechanism based on negative pressure, sufficient force can be generated in the case of a small suction opening only with a high negative pressure in order to hold the fabric layers. The fabric layer deforms, which could in particular make the ironing necessary in a next working step. On the other hand, large suction openings deform the textile material so strongly, even with little negative pressure, that it no longer lies sufficiently flat in the x-y plane. In addition, during the positioning on another fabric layer, the latter can also still be drawn in, which counteracts the exact positioning. For this reason, a solution was chosen which uses a plurality of small suction openings (which are distributed over a larger area or edge). Good results are thus achieved with more than 9, in particular more than 15, preferably more than 22, especially preferably more than 30 suction openings. The experiments with respect to smaller diameters of these suction openings have shown that the fabric layers hold in a flat manner in the x-y plane. This in particular prevents warping and fold formation for the later depositing.

According to a further exemplary embodiment, the suction openings are formed with a diameter of less than 20 mm, in particular less than 10 mm, further in particular less than 5 mm, further in particular less than 3 mm. Good results were thus achieved with more than 9, in particular more than 15, preferably more than 22, especially preferably more than 30 suction openings. The experiments with respect to diameters of these suction openings have shown that diameters of less than 20 mm, in particular less than 10 mm, further in particular less than 5 mm, further in particular less than 3 mm are of especial advantage because, for example, a supporting material inserted between fabric layers holds the fabric part in a flat manner in the x-y plane. This in particular prevents warping and fold formation for the later depositing.

According to a further exemplary embodiment, the monitoring device comprises a sensor for measuring an electromagnetic field, wherein the electromagnetic field strength is indicative of whether the handling mechanism holds a fabric layer, whether multiple fabric layers are held or whether no fabric layer is received.

In an exemplary embodiment, the handling mechanism comprises an electrostatic gripping device. For example, a contact surface, for example made of metal, can be formed on the effector, to which electrodes are coupled, which serve as a potential source and can thus generate an electrostatic force of attraction with the fabric layers. During the reception with an electrostatic gripping device, the energy flow thereof and/or the damping thereof depending on a successful reception of an individual fabric part can then be evaluated by means of a capacitively coupled electromagnetic field.

According to a further exemplary embodiment, the handling mechanism is configured to detect a fabric layer at fixing points at which the handling mechanism fixes the fabric layer. The handling mechanism is further configured such that the fixed fabric layer can be spanned by moving the fixing points. Additionally or alternatively, the handling mechanism is further configured to fix the fabric layer at further fixing points within the effector contour and/or to re-span it with the further fixing points. For example, corresponding vacuum suction units, electrostatic attraction elements or mechanical grippers can be arranged at the fixing points. Corresponding movable fixing elements, such as holding rods, which can be extended and retracted, for example, telescopically or by means of a joint-like connection, can be fastened to the effector, wherein a corresponding handling mechanism is fastened to the holding rods. A fixing point can then, for example, be moved by moving the fixing elements and a spanning of the held fabric layers can be enabled accordingly. In particular in the case of larger pieces of fabric, there is the risk that these sag if they are lifted only at the relevant contour points, for example at the edge of the effector contour. For this reason, additional fixing points, thus corresponding handling mechanisms, can also be placed within the spanned effector contour, which holding points hold the piece of fabric in the spanned plane (even in the case of rapid position changes of the effector) and/or the holding rods or the grippers can pre-span the piece of fabric in the direction “away from the center” after picking up the piece of fabric.

According to a further exemplary embodiment, the handling mechanism is further configured such that the fabric layers can be received individually from two spaced fabric layer stacks. One of the major tasks in the case of a subsequent automatic packaging (German: Konfektionierung) is the turning of fabric layers from “right” to “left” (or vice versa). This task can already be addressed during the singulation of a fabric layer from the fabric layer stack, in which either a fabric layer stack is available “on the left” and a fabric layer stack is available on the “right” or in which the fabric layers are already stacked prior to the cutting such that one layer is “left” and one layer is “right”. As a result, after the singulation, a double layer can be created in a simplified manner, in which two fabric layers touch one another, which are on the “right” and thus the left-side surface is on the outside, which corresponds to the usual side for stitching. The dynamic gripping variations of the handling mechanism according to the disclosure for the singulation thus are especially effective, because the left and the right side of a fabric layer usually have slightly different quality requirements and/or technical properties.

According to a further exemplary embodiment, the effector comprises at least two handling mechanisms which are selectively controllable for fixing one of the fabric layers or the fabric layer stack, wherein the at least two handling mechanisms are activatable and controllable in particular in a location-dependent manner and/or depending on a sensor value and/or depending on a manipulation step and/or a joining step.

According to a further exemplary embodiment, the effector comprises at least one fixing element at which the handling mechanism or the fixing points at which the handling mechanism is present are formed. The handling mechanism is further configured to fix and convey the fabric layer stack for handling to the joining unit, in particular within the effector contour. The handling mechanism is, for example, selected from the group consisting of grippers, suction units, clamps, regions with increased friction and/or electrostatic attraction, holding needles, rollers, freezing grippers, and/or Bernoulli grippers.

Electroadhesive grippers for electrostatic attraction work with electrostatic fields. Holding forces are generated by polarization. They can be generated on the upper side of the fabric layer, which is in contact with a gripper dielectric of the electroadhesive gripper.

A Bernoulli gripper has a suction body, wherein compressed air is flowed outward between the fabric part and the suction body along the x-y plane via a flow channel of the suction body at the edge regions of the suction body. An air opening, which is coupled to the flow channel, is located in the center of the suction body. On account of the Bernoulli effect, air is sucked into the flow channel from the direction of the fabric part. A fixing force of the fabric part on the suction body is therefore generated.

A freezer gripper has a strongly cooled contact surface with the fabric part, as a result of which frozen water or ice as adhesive adheres the fabric part to the contact surface. The water can be obtained as adhesive from the atmosphere (atmospheric humidity) or can be added by an adhesive supply.

In other words, for example, a plurality of (identical or different) handling mechanisms can be arranged on a carrier rod of a fixing element.

According to a further exemplary embodiment, the handling mechanism is controllable such that different gripping intensities for fixing one of the fabric layers or a plurality of fabric layers are controllable. If fabric layers of different thickness, different technical/haptic properties or different layering “left”/“right” have to be processed with the handling mechanism, it is advantageous if the gripping can be controlled in a further degree of freedom, namely with the different gripping intensity. In particular, a different gripping intensity and also a different handling mechanism can be selected if the gripping of the fabric layer is a left side or a right side of the fabric part. For example, the left side of a fabric layer can be gripped gently with a suction device, while the left side can be received with holding needles, since a stroke (German: Strich) on the left side of the fabric layer is acceptable. Furthermore, the gripping intensity and/or the type of handling mechanism can be selected in a location-dependent manner with respect to the fabric layer. For example, an effector can comprise a handling mechanism for large fabric layers with a large area and, at another region of the effector, a handling mechanism with a plurality of fixing points standing closely together. Thus, depending on the type of fabric layer, a location-dependent gripping can be selected with the one handling mechanism at the effector or with the other handling mechanism at the effector. Furthermore, the gripping intensity can be selected depending on the process step of the handling robot. For example, when lifting and separating a fabric layer from the fabric layer stack, a larger gripping intensity can be selected, for example a high suction power of a suction device can be present, but less gripping intensity, i.e. less suction power of the suction device when displacing the fabric layer along the worktable. In the example of the suction device, it can also be prevented with a corresponding control of the suction power that the suction device, for example, sucks on the worktable.

The fixing elements comprise, for example, respectively at least one carrier rod (or, as described below, a framework of coupling rods), which is movably fastened to the effector with one end. Corresponding fixing devices or fixing mechanisms are provided along the carrier rod or at a free end of the carrier rod, such as, for example, a gripper or a holding needle device which comprises holding needles for holding the fabric piece. The carrier rod can be fastened to the effector in particular pivotably and/or translationally displaceably. Furthermore, the carrier rod can, for example, be extended and retracted telescopically in order to change its length. In addition, the carrier rod itself can comprise at least one joint, so that the carrier rod itself comprises two partial regions which can be pivoted relative to one another. An exact setting and adjustment of the gripping device of a fixing element can thus be enabled. The adjustment of the effector contour of the effector can, for example, be enabled by integrated actuators (e.g. stepper motors with mechanical transmission to the fixing elements).

The fixing elements are arranged at the effector such that at least one fixing element or all guide elements comprise two degrees of freedom per arm in an x-y plane and in particular a further additional degree of freedom in the z-plane (for folding away inactive grippers).

The x-y plane is defined as that plane in which the fabric layer is present when it is fixed by the fixing elements. In particular, the fabric layer is spanned between the fixing elements. In this spanned state, the fabric layer has a flat shape and thus lies within the x-y plane. The normal of the x-y plane forms the z-direction. In other words, the x-y plane forms the fabric plane and the thickness of the fabric is defined along the z-direction.

According to a further exemplary embodiment, the monitoring device generates monitoring data which describe the number, the orientation and/or the characteristic of the fabric layer which is fixed to the handling mechanism, wherein the handling mechanism is controllable based on the monitoring data. The monitoring data can, for example, be acquired and monitored with the sensors described above. For example, the data are processed in a control unit. The control unit can further be configured for controlling the handling robot and in particular the handling mechanism. In a further embodiment, the handling mechanisms are adapted in real time based on the sensor signals. For example, an electronic weighing device or the weight sensor of the fabric stack or of the load weight at the effector can detect whether only one fabric layer has actually been singularized. Alternatively, the optical sensor can monitor the progress of the manipulation in different working steps and at most react to the handling mechanism or the manipulation. In particular, mechanisms of artificial intelligence for the fold detection or prevention can be used for this purpose. In addition, a learning process can improve the recognition and/or the reaction to the robotics/the gripping of this embodiment. For the fold detection, the unevenness can be detected by means of a 3D scan of the surface of the singulated fabric part. From a certain degree of unevenness (in particular, if the first derivative of the Z-height of a measurement line in one of the coordinate directions delivers a conspicuous impulse response), a fold formation can be assumed. As a countermeasure, the fabric layer can be lifted again and deposited again, or the fabric layer is sorted out onto an error stack. Such an embodiment can ensure that only one fabric part is received during the singulation.

In an exemplary embodiment, the control unit is configured for controlling the handling robot and/or the joining unit, wherein the control unit is configured to collect and evaluate the data relating to the movement of the effector and data relating to the joining result of the joining unit and in particular the monitoring data in order to take measures relating to the control of the movement of the effector and of the joining sequence of the joining unit in the event of a predetermined deviation from a predefinable limit value. The control unit can be coupled to the individual sensors of the system in a wireless or wired manner in order to obtain the corresponding movement data, position data and state data of the effector as well as the data of the joining unit as well as the state data of the joint or of the joining result of the fabric part. Furthermore, the control unit can be equipped with a storage unit with a database or with the data processing unit or can be coupled to a remote, web-based database or database stored in a cloud. For example, target values for the data or measured parameters can be present in the database. Based on an actual/target value comparison, the control unit can generate corresponding control commands for the system. In other words, the system according to the disclosure uses the knowledge from the sensory evaluation as to whether the respective manipulation was successful. Thus, a change in the reliability can be recognized and communicated to a higher-level system. As a result, for example, preventive maintenance or an adaptation of the handling parameters can be initiated.

According to a further exemplary embodiment, the handling mechanism comprises a holding needle device with holding needles which is configured such that a penetration depth and/or a penetration angle of at least one holding needle is controllable, in particular in real time and/or based on a sensor feedback.

The holding needle device is configured to introduce holding needles into the fabric layers for fixing. By means of the holding needle device, either from the effector side, from the worktable side or from an auxiliary system (for example auxiliary plate, needle tape), one or more needle-like pins or holding needles can be driven out of a magazine into or through the fabric layers in order to fasten them to one another and/or to the effector. The holding needle device comprises in particular a feeding device, for example a holding needle magazine, which is configured to feed holding needles for the holding needle device.

An additional form of differentiated gripping can relate to the depth of a penetration needle or holding needle and/or the angle of a holding needle (and in particular a plurality thereof). Thus, for example, a holding needle can be inserted into the fabric layer at a shallow angle or not so deep during singulation, whereas in the case of thicker fabric layers, a steeper angle or a larger penetration depth can be used in order to securely access the fabric layer or the fabric layers.

According to a further exemplary embodiment, the holding needles comprise a diameter of less than 1300 micrometers, in particular less than 900 micrometers, in particular less than 550 micrometers, further in particular less than 250 micrometers. It has been found that in the case of fine microneedles as holding needles in combination with a suitable vacuum negative pressure and a suitable air stream, no quality-disturbing effects remain on the fabric surface after the processing. This has been shown especially in the case of needle diameters of less than 1300 micrometers, in particular less than 900 micrometers, in particular less than 550 micrometers, preferably less than 250 micrometers.

According to a further exemplary embodiment, the handling mechanism comprises a support element, in particular a support plate, for supporting the at least one fabric layer to be conveyed, wherein the handling mechanism is configured in particular such that the fabric layer is liftable and the support element is conveyable below the fixed fabric layer. The support element can, for example, have a fork shape, or the support plate can comprise a round support surface or an angular support surface. Furthermore, the support element can comprise an adhesive surface, so that the fabric layer does not slip down unintentionally during the transport or the joining. The support element can, for example (e.g. via a further robot arm) be arranged in an articulated manner at the effector in order to be inserted correspondingly below or between the fabric layers.

In other words, the uppermost fabric layer or the uppermost fabric layers of a fabric layer stack can therefore be lifted. For this purpose, the handling mechanism can lift the uppermost fabric layer or at least one rim or one edge by means of the explained exemplary embodiments (e.g. by means of a temporary adhesive, with holding needles or microneedles, by means of a Bernoulli gripper or by means of sucking units or vacuum), so that the support element can be moved in between, i.e. can be transported subsequently between the uppermost fabric layer(s) and the fabric layers lying thereunder or the worktable. In other words, the support element first moves in the x- or y-direction below the fabric layer to be lifted, so that at the beginning the front edge of the support element is parallel to the straight cut edge of the fabric layer. When the support element is completely (or at least) pushed under, the support element together with the fabric layer to be lifted is lifted vertically or in the z-direction and thus singularized from the rest of the fabric layers lying thereunder.

According to a further exemplary embodiment, the handling mechanism is configured such that a joining region of the fabric layer, at which a joining step of a joining unit is performable, forms a protrusion with respect to the effector contour of more than 0.5 cm, in particular more than 1 cm, further in particular more than 2 cm or more than 3 cm. The joining regions are defined by the material protrusion thus produced and a subsequent joining becomes possible. The joining region can then be placed on at least one other free joining region of a further fabric layer. Alternatively, the joining region can be manipulated such that it is folded (e.g. for a seam) and thus form it from a fabric layer. It is of especial importance here that all handling mechanisms or fixing points are located within the effector contour. As a result, it becomes possible to mask out (German: ausblenden) edge effects which are characterized in particular by the cutting method of the fabric layers (fibers which become jammed with the next lower layer, cutting edge bends in the case of stiffer seams, cut-induced fibering out of woven fabric, cutting fringes (German: Schnittbrausen), etc.) or to control them in handling.

A joining region of a fabric layer describes a region which is to be processed with a joining unit. The joining region can be, for example, that region of a fabric layer at which a seam or a seam can run. In particular, joining regions of two fabric layers lying on top of one another are placed on top of one another so that they can be connected by means of the joining unit (for example by means of sewing or welding).

According to a further exemplary embodiment, the system further comprises the work table with the work surface, wherein the work table comprises a hold-down device which is configured to selectively fix the fabric layer at the work table, in particular by means of electrostatic holding forces. The hold-down device can press with a force against the work table/the work surface, which leads to a fixing of the two fabric layers lying in between. Alternatively, the effector can also allow compressed air to flow in between its underside and the fabric layers. This is particularly helpful when the effector has to reposition itself so that it can quickly overcome the adhesive forces between the effector and the first fabric layer. This allows a safe and flat deposition of a fabric part after the singulation.

According to a further exemplary embodiment, the monitoring device comprises an air humidity sensor. The handling mechanism, which is in particular configured as an electrostatic handling mechanism, is controllable based on the measured air humidity. The system furthermore comprises an air humidifying device for adjusting the air humidity, wherein the air humidifying device is controllable based on the measured air humidity. The air humidity can be measured in the ambient air of the working region and in particular in the vicinity or in the fabric stack. From the determined humidity values, the air humidity can be increased by a suitable additional device (e.g. an air humidifying device) so that no disturbing electrostatic effects act and/or influences of the gripping mechanism are triggered (e.g. higher holding forces if the fabric layers are moist and thus heavier). In particular, electrostatic gripping systems are strongly influenced by material moisture and air humidity, so that such an application is especially recommended there.

According to a further exemplary embodiment, the monitoring device is configured to detect incorrect grips or incorrect placements of the fabric layer at the handling mechanism, wherein the handling mechanism is configured to deposit and re-grip the fabric layer upon detection of incorrect grips or incorrect placements. The incorrect grips can in particular be detected by the monitoring device and its described sensors. It can thus be effectively prevented that during handling a fabric layer is not correctly aligned on account of incorrect handling (e.g. excessively compressed and corresponding fold formation) or joints between two fabric layers are not correctly aligned by incorrect positioning.

According to a further exemplary embodiment, the effector is configured to be exchangeable. The system can comprise an effector exchange device which is configured to automatically couple and decouple an effector from the handling robot. The effector exchange device is in particular configured to automatically couple and decouple supply lines to the effector. The effector exchange device is further configured to convey the effector between a storage location and the handling robot. The effector can thus be deposited at a standing location and another effector can be coupled to the handling robot. The required connections to resources (energy, compressed air, vacuum, data, control lines) are also connected and dust-tightness is ensured. The contour issue can thus be solved in the case of fabric pieces of different sizes.

The effector exchange device is for example arranged at a storage location, at which a plurality of different effectors can be stored with different handling mechanisms. The handling robot can place the effector at a predetermined location of the effector exchange device by moving its robot arm. The effector exchange device can be arranged locally at the storage location for receiving the effector. For example, an automatic coupling and decoupling can take place at the robot arm in order to place the effector at a desired location at the effector exchange device. The effector exchange device can further comprise coupling elements, such as for example decoupling tools, in order to release corresponding fluid lines or lines between the effector and the robot arm or to connect them during coupling. Furthermore, the effector exchange device itself can comprise a robot arm and move to the coupling location of the effector. By means of a decoupling tool, the effector exchange device can correspondingly decouple and couple the effector.

In an exemplary embodiment, the system can in particular comprise an effector cleaning unit at the storage location in order to clean the effector. At the storage location, the unused effector can be (automatically) cleaned with the effector cleaning unit. In particular, surfaces with a specific frictional resistance require regular cleaning in order to ensure the desired frictional effects. In addition, sensors, such as, for example, optical lenses of the optical sensor, or also parts of the suction device or of the vacuum system can be cleaned with the effector cleaning unit.

According to a further exemplary embodiment, the effector is configured to press down the fabric layer on a work surface of a work table. Depending on the fabric layer properties, further fabric layers can be lifted during the singulation. For this reason, the robot can carry out a hold-down action before the singulation and, for example, press on the fabric layer stack. This can be, for example, a brief pressing down of the fabric stack (without activated grippers), so that the air between the fabric layers can escape laterally. Here, in turn, the contour reduction or the reduced effector contour of the effector is of advantage since there is less obstruction for outflowing residual air between the fabric layers when the fabric layer stack is compressed.

According to a further exemplary embodiment, the effector is configured, in particular when a fold is detected by means of the monitoring device, to carry out a smoothing action of the fabric layer. In order to carry out the smoothing action, the effector is configured in particular such that the effector supports the fabric layer on a work table and changes fixing points of the handling mechanism with the fabric layer, so that a smoothing of the fabric layer can be carried out.

Additionally or alternatively, in order to carry out the smoothing action, the effector can comprise a roller unit, which is configured in particular such that the effector supports the fabric layer on a work table and smooths the fabric layer by means of the roller unit.

Additionally or alternatively, in order to carry out the smoothing action, the effector can be configured in particular such that a repositioning and correspondingly a smoothing of the fabric layer can be carried out by means of lifting and repositioning on a work table.

Additionally or alternatively, in order to carry out the smoothing action, the effector can be configured in particular such that a shaking movement can be carried out by means of the effector in order to achieve a smoothing of the fabric layer.

Additionally or alternatively, in order to carry out the smoothing action, the effector can comprise a blow-out unit for blowing out compressed air in the direction of the fabric layer, which blow-out unit is configured in particular such that compressed air can be blown onto the surface of a fabric layer in order to span the same for the reduction of folds.

Additionally or alternatively, in order to carry out the smoothing action, the effector can comprise a smoothing plate, in particular a heatable smoothing plate, and can be configured such that a smoothing can be carried out by means of pressing the smoothing plate onto the fabric layer.

Additionally or alternatively, in order to carry out the smoothing action, the effector can comprise an elastic and/or inflatable punch (so-called fulling (German: Walken)) and can be configured such that the surface of the punch can be enlarged by means of pressing the punch onto the fabric layer and thus a smoothing of the fabric layer can be carried out. On account of a frictional surface between the punch and the fabric layer, the fabric layer is separated when the surface of the punch is enlarged and folds are reduced.

According to a further exemplary embodiment, the system comprises a loosening unit (German: Auflockerungseinheit) for loosening the fabric layer stack, wherein the loosening unit is arranged at a work table next to a fabric layer stack and/or at the effector. The loosening unit comprises, for example, a shaking unit for shaking the fabric layer stack, a compressed air unit for laterally blowing compressed air into the fabric layer stack and/or an elastostatic unit for statically charging the fabric layers of the fabric layer stack.

For example, the effector can press on the fabric layer stack and at the same time loosen the fabric layer stack with compressed air and/or with a mechanical movement of the loosening unit, which can be mounted in a stationary manner at the work table or at the effector. For example, the loosening unit can blow in compressed air, in particular laterally, over the cut edges of the fabric stack. Here, in turn, the smaller effector contour of the effector compared with the corresponding outer fabric layer contour is of advantage since the edge zones are thus free for a loosening movement. Alternatively, a shaking mechanism can also loosen the fabric stack. In the case of fabric stacks, this can be achieved by means of electromagnetic/electrostatic effects or compressed air passing laterally. Since electrostatic forces repel one another and/or compressed air passing by generates a negative pressure, the uppermost fabric layer is detached the most and thus prepared for the singulation. This leads to a further increase in the reliability of the singulation. If such an auxiliary mechanism is mounted at the table instead of at the movable part of the robot, the robot has to accelerate less weight, which means a speed advantage.

According to a further exemplary embodiment, the system comprises a feeding unit, which is configured to convey a fabric layer stack. The feeding unit is configured to convey a fabric layer stack from a storage area to a work table, at which fabric layers of the fabric layer stack can be singulated by means of the handling mechanism of the effector. The feeding unit can comprise, for example, a conveyor belt and/or a manipulator (for example a further handling robot or a forklift truck), which conveys the fabric layer stack from the storage area to the work table. The fabric layer stack is automatically brought from a storage area into the working region of the singulation according to the disclosure. Since the singulation system can obtain sufficiently precise information on the basis of the additional monitoring of the singulation as to when a successful singulation is finished, a prediction can be derived therefrom as to when the next singulation can take place (at the earliest). This is of functional importance especially in the case of a change of fabric layer stack, in order thereby to prevent pauses and waiting times, since the automatic feeding of another fabric layer stack from a storage area requires a certain lead time before the singulation of the first fabric part from this fabric layer stack.

According to a further exemplary embodiment, the effector comprises a contact surface, on which one of the fabric layers or the fabric layer stack can be placed within the effector contour. This allows the fabric layer to be transported in a warp-free and fold-free manner and to be deposited later.

In particular, a fold formation can thereby be efficiently reduced and no mechanism for flattening is needed after the placement. The contact surface forms in particular a part of the handling mechanism for fixing one of the fabric layers or the fabric layer stack, wherein the contact surface is configured such that one of the fabric layers or the fabric layer stack is held magnetically, based on air pressure, mechanically or electrostatically on the effector. The contact surface allows the fabric layers or the fabric layer stack to be transported in a warp-free and fold-free manner and to be deposited later. After the positioning or stacking of the fabric layers, the fabric layers can be fixed more easily with the contact surface. The contact surface can, for example, be part of a magnetic device and be configured to be correspondingly magnetic. Furthermore, the contact surface can hold the fabric layers with negative pressure, with mechanical elements (e.g. continuous microneedles) or with electrostatic elements. According to a further exemplary embodiment, the contact surface forms a suction surface as part of the handling mechanism, on which one of the fabric layers or the fabric layer stack can be placed.

According to a further exemplary embodiment, the system comprises a data processing unit which is configured to provide fabric layer data relating in particular to fabric layer material and/or fabric layer geometry. The data processing unit is further configured to provide processing data, in particular left/right position, alignment, unfolding and/or production quality of one of the fabric layers or of the fabric layer stack. Information details for placing the fabric layers can therefore be transferred from the system to a subsequent handling system for the next working step. The new recording of position details, material details and/or left/right placement of the fabric layer can thereby be omitted. It has been shown that in particular details relating to material properties, left/right position, location, unfolding and/or production quality are suitable for transfer.

In particular, knowledge from the sensory evaluation as to whether the respective manipulation or handling was successful can be used with the control unit, in particular in conjunction with the data processing system. Thus, a change in the reliability can be recognized and communicated to a higher-level system. As a result, for example, preventive maintenance or an adaptation of the handling parameters can be initiated.

According to a further exemplary embodiment, the effector comprises at least two, in particular different, handling mechanisms, wherein the two handling mechanisms comprise different handling mechanisms and/or apply different gripping intensities on the left and the right side of one of the fabric layers or of the fabric layer stack. The different handling mechanisms can comprise, for example, on the one hand an electrostatic handling mechanism and/or on the other hand a negative-pressure-based (for example a suction device) handling mechanism which are controlled differently for the singulation than for other manipulation steps. Thus, for example, only a part of the vacuum suction units present of a suction device can be activated for the singulation so that a plurality of fabric layers are not detected, but afterwards all suction units can be activated so that the fabric layer remains securely fixed in the case of rapid position changes of the effector. The same principle can also be implemented in the case of electrostatic/electromagnetic gripping systems of the handling mechanism in that the total holding force of such a handling mechanism can be correspondingly varied.

According to a further exemplary embodiment of the method, the effector is configured to wait more than 1 second, in particular more than 2 seconds, in particular more than 4 seconds, in particular more than 8 seconds until the next singulation from the same fabric layer stack between two singulations, in which respectively a fabric layer is singulated from the fabric layer stack by the handling mechanism. The receiving and handling of a fabric layer from a fabric layer stack can lead to a lifting of the fabric layers lying further down. It has been shown that by inserting a pause between two singulations from the same fabric layer stack, the lifted layers can sink back again. It has thus been shown that a safe singulation of desired fabric layers is achieved if more than 1 second, in particular more than 2 seconds, preferably more than 4 seconds, especially preferably more than 8 seconds is waited until the next singulation from the same fabric layer stack. The sinking back of the fabric layers can be assisted by sucking the fabric layers in the fabric layer stack onto a work table, on which the fabric layers in the fabric layer stack rest. The work table comprises, for example, suction openings, so that the fabric layers can be drawn in onto the work table by means of negative pressure. The time between two singulations can therefore be shortened.

It is pointed out that the embodiments described here represent only a limited selection of possible embodiment variants of the disclosure. It is thus possible to combine the features of individual embodiments with one another in a suitable manner, so that a plurality of different embodiments are to be regarded as obviously disclosed for the person skilled in the art with the embodiment variants explicit here. In particular, some embodiments of the disclosure are described with device claims and other embodiments of the disclosure with method claims. However, the person skilled in the art will immediately understand when reading this application that, unless explicitly stated otherwise, in addition to a combination of features which belong to a type of subject matter of the disclosure, an arbitrary combination of features which belong to different types of subject matter of the disclosure is also possible.

### BRIEF DESCRIPTION OF THE DRAWINGS

Exemplary embodiments are described in more detail below with reference to the appended drawings for further explanation and for better understanding of the present disclosure. In the drawings:

FIG. 1 shows a schematic illustration of a system for handling fabric layers according to an exemplary embodiment.

FIG. 2 shows a schematic illustration of an effector with a handling mechanism according to an exemplary embodiment.

FIG. 3 shows a schematic illustration of a handling mechanism with a suction surface according to an exemplary embodiment of the present disclosure.

FIG. 4 shows a schematic illustration of a system for handling and processing fabric layers with fixing elements arranged on the effector according to an exemplary embodiment.

FIG. 5 shows a schematic illustration of a system with an effector exchange device according to an exemplary embodiment.

FIG. 6 shows a schematic illustration of a system with a roller unit for carrying out a smoothing action according to an exemplary embodiment.

FIG. 7 shows a schematic illustration of a system with a blow-out unit for carrying out a smoothing action according to an exemplary embodiment.

FIG. 8 shows a schematic illustration of a system with a smoothing plate for carrying out a smoothing action according to an exemplary embodiment.

FIG. 9 shows a schematic illustration of a system with a punch for carrying out a smoothing action according to an exemplary embodiment.

FIG. 10 shows a schematic illustration of a system with a loosening unit for supporting a separation of fabric layers according to an exemplary embodiment.

### DETAILED DESCRIPTION OF EXEMPLARY EMBODIMENTS

Identical or similar components in different figures are provided with identical reference numerals. The illustrations in the figures are schematic.

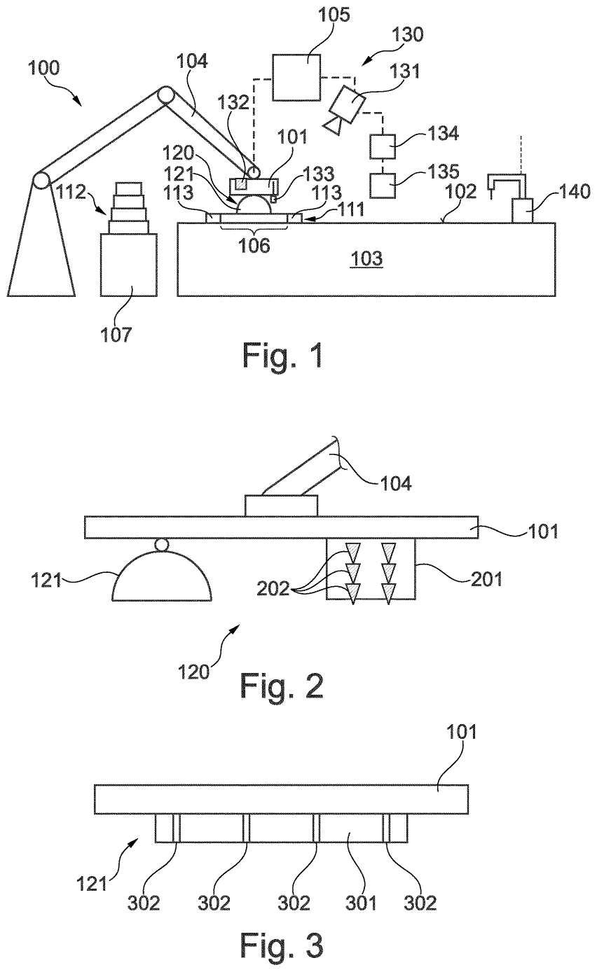

FIG. 1 shows a schematic illustration of a system 100 for handling fabric layers 111 according to an exemplary embodiment. The system comprises a handling robot 100 with an effector 101 for handling fabric layers 111, wherein the effector 101 comprises a handling mechanism 120 which is configured to receive and deposit at least one fabric layer 111. The handling mechanism 120 comprises an effector contour 106, wherein the fabric layer 111 can be fastened within the effector contour 106, wherein the effector contour 106 is smaller than an outer contour of the fabric layer 111. The handling mechanism 120 is configured to singulate and receive at least one fabric layer 111 individually from a fabric layer stack 112, to deposit at least one singulated fabric layer 111 in a flat manner on a work surface 102 of a work table 103, and to span the fabric layer 111 within the effector contour 106 in a fold-free manner. Furthermore, the system comprises a monitoring device 130, which is configured to monitor the singulation of the at least one fabric layer 111 from the fabric layer stack 112.

The handling mechanism 120 is configured to singulate and receive at least one fabric layer 111 individually from a fabric layer stack 112, wherein the handling mechanism 120 is further configured such that at least one singulated fabric layer 111 is deposited in a flat manner on a work surface 102 of a work table 103 and to span the fabric layer 111 within the effector contour 106 in a fold-free manner.

Furthermore, the system comprises a monitoring device 130, which is configured to monitor the singulation of the at least one fabric layer 111 from the fabric layer stack 112. In other words, the monitoring device 130 can monitor the process of the singulation of the at least one fabric layer 111 and thus ensure whether, for example, the predetermined number, i.e. one or a specific number of fabric layers 111 are handled.

The handling robot 100 comprises the effector 101, to which the corresponding handling mechanism 120 is, in particular exchangeably, attached. The handling robot 100 is fastened with a stationary robot base to the floor or to the work table 103 in order to introduce corresponding forces into the corresponding system. Alternatively, the handling robot 100 can also be configured such that the robot base is designed to be movable along the floor. A robot arm 104 can be arranged between the effector 101 and the robot base, which robot arm comprises, for example, one or more joints in order thus to control the effector 101 into a desired position.

The controllable handling mechanism 120 is arranged at the effector 101. The handling mechanism 120 conveys one or more fabric layers 111. The fabric layers 111 can be placed loosely one on top of the other and can be gripped as a stack (for example by means of negative pressure or by means of a mechanical gripper of the handling mechanism 120), or the fabric layers 111 are fastened to one another, for example temporarily. The handling mechanism 120 can convey the fabric layers 111 to a joining unit 140. The effector 101 or the handling mechanism 120 can adapt to the contour of the fabric layers 111, for example by fixing points of the handling mechanism 120 being adjustable to which the fabric layers 111 are fixed. For example, the fixing elements 401 described below can be arranged for this purpose, in which the individual fixing points are formed. The handling mechanism 120 covers in particular the outline-relevant points of a contour of the fabric layer 111, wherein an edge of the fabric layers 111 preferably remains free as a joining region 113 and is not covered by the handling mechanism 120. The region of the fabric layers 111 which is covered by the effector 101 or the handling mechanism 120 for fixing the fabric layers 111 is referred to below as the effector contour 106. The effector 101 comprises a contact surface, on which one of the fabric layers 111 or the fabric layer stack 112 can be placed within the effector contour 106. This allows the fabric layer 111 to be transported in a warp-free and fold-free manner and to be deposited later.

The effector 101 thus forms an end part of the handling robot 100 with, for example, grippers as a handling mechanism 120 which grip and manipulate a fabric layer 111 (for example a planar unprocessed fabric layer 111 or an entire item of clothing as a fabric layer 111) or a fabric layer stack 112 which consists of fabric layers 111 which are fastened by a fixing mechanism.

The joining unit 140 is configured to process the joining regions of a fabric layer 111 and/or to connect at least two fabric layers 111. The joining unit 140 can be a sewing machine, a welding machine, a stitching machine, a crocheting machine, an automatic gluing machine or further automatic connecting machines for fabric layers 111. The joining unit 140 can connect two fabric layers 111 to one another, for example, so that a seam (fabric seam or weld seam, etc.) is produced. The seam describes, for example, the connection of two fabric layers 111 by means of a thread or yarn, wherein at least the one material substantially represents a fabric, a non-woven fabric or a woven fabric.

According to the approach of the present disclosure, in particular a monitoring device 130 is provided which monitors a singulation of the at least one fabric layer 111 or the plurality of fabric layers 111 from the fabric layer stack 112. It can thus be ensured that an exact orientation of the fabric layers 111 and an exact depositing of the fabric layers 111 is enabled for a later further processing, for example at the joining unit 140. The monitoring device 130 can in particular also recognize the fold-free state of the fabric layers 111 when they are picked up by the handling mechanism 120 within the effector contour 106.

The monitoring device 130 comprises an optical sensor 131, in particular a monitoring camera. The optical sensor 131 is configured to detect a singulated fabric layer 111, which is received by the handling mechanism 120. By means of an optical sensor 131, e.g. a camera and a suitable subsequent evaluation, both the receiving of the fabric layers 111 and the fold-free positioning after the depositing can be ensured.

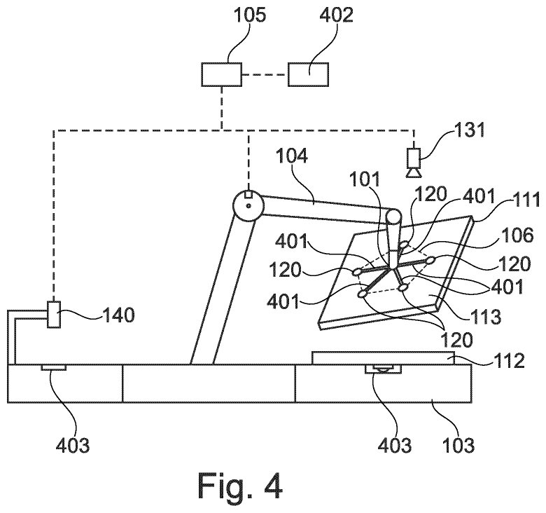

Furthermore, the monitoring device 130 comprises a weight sensor 132, wherein the weight sensor 132 is arranged at the effector 101 such that a weight of the fabric layer 111 received by the handling mechanism 120 is measurable. Additionally or alternatively, a weight sensor 403 is installed in the work table 103 (see FIG. 4) and configured such that a weight change of the fabric layer stack 112 is measurable before and after the singulation of a fabric layer 111.

Furthermore, the monitoring device 130 comprises a distance sensor 133 to determine the presence of a singulated fabric layer 111 at the handling mechanism 120. Furthermore, the monitoring device 130 comprises the possibility to monitor a presence of a fabric layer 111 which is held by the handling mechanism 120 and, for example, also the thickness of the fabric layers 111 or the total thickness of the fabric layers 111 at the effector 101.

In the embodiment of FIG. 1, the handling mechanism 120 comprises a suction device 121 which is configured to singulate and receive a fabric layer 111 from the fabric layer stack 112 by means of negative pressure. The monitoring device 130 comprises, for example, a vacuum sensor which is configured to measure an air flow of the suction device 121, wherein the air flow is indicative of whether the suction device 121 holds a fabric layer 111, whether multiple fabric layers 111 are held or whether no fabric layer 111 is received.

The suction device 121 comprises, for example, at least one suction unit, wherein the suction device 121 is configured to suck air from at least one fabric layer 111 to be held by means of the suction unit in such a way that the fabric layers 111 can be fixed to the suction device 121. Since the fabric layers 111 are air-permeable to a certain degree on account of their material properties, one, two or more fabric layers 111 can be fastened in a fabric layer stack 112 by means of suction with a correspondingly set suction power. The suction device 121 comprises, for example, a vacuum pump which can be arranged spaced apart from the effector 101, for example at the work table 103. One or more suction units, such as suction cups, for example, can be fastened to the effector 101 as part of the handling mechanism 120.

Furthermore, the suction device 121 with the suction units can also form parts of the handling mechanism 120 in order to align and convey the fixed fabric layers 111. In an exemplary embodiment, the suction device 121 also forms parts of the handling mechanism 120 for handling the fabric layers 111.

The handling mechanism 120 is, for example, selected from the group consisting of grippers, suction units, clamps, regions with increased friction and/or electrostatic attraction, holding needles, rollers, freezing grippers, and/or Bernoulli grippers.

The handling mechanism 120 is in particular controllable by the control unit 105 such that different gripping intensities for fixing one of the fabric layers 111 or a plurality of fabric layers 111 are controllable.

The monitoring device 130 generates monitoring data which describe the number, the orientation and/or the characteristic of the fabric layer 111 which is fixed to the handling mechanism 120, wherein the handling mechanism 120 is controllable based on the monitoring data. The monitoring data can, for example, be acquired and monitored with sensors 131, 132, 133. The data are, for example, processed in the control unit 105. The control unit 105 can further be configured for controlling the handling robot 100 and in particular the handling mechanism 120.

The control unit 105 is thus configured for controlling the handling robot 100 and/or the joining unit 140, wherein the control unit 105 is configured to collect and evaluate the data relating to the movement of the effector 101 and data relating to the joining result of the joining unit 140 and in particular the monitoring data in order to take measures relating to the control of the movement of the effector 101 and of the joining sequence of the joining unit 140 in the event of a predetermined deviation from a predefinable limit value. The control unit 105 can be coupled to the individual sensors of the system in a wireless or wired manner in order to obtain the corresponding movement data, position data and state data of the effector 101 as well as the data of the joining unit 140 as well as the state data of the joining position or of the joining result of the fabric part.

The system further comprises a feeding unit 107, which is configured to convey a fabric layer stack 112. The feeding unit 107 is configured to convey a fabric layer stack 112 from a storage area to a work table 103, at which fabric layers 111 of the fabric layer stack 112 can be singulated by means of the handling mechanism 120 of the effector 101. The feeding unit 107 can comprise, for example, a conveyor belt and/or a manipulator (for example a further handling robot 100 or a forklift truck), which conveys the fabric layer stack 112 from the storage area to the work table 103.

FIG. 2 shows a schematic illustration of an effector 101 with a handling mechanism 120 according to an exemplary embodiment. The effector 101 comprises at least two, in particular different, handling mechanisms 120, wherein the two handling mechanisms 120 comprise different handling mechanisms and/or apply different gripping intensities on the left and the right side of one of the fabric layers 111 or of the fabric layer stack 112. For example, the effector 101 comprises a suction device 121 and a holding needle device 201. The suction device 121 and the holding needle device 201 can be selectively controlled for fixing one of the fabric layers 111 or the fabric layer stack 112.

The holding needle device 201 comprises holding needles 202 which are configured such that a penetration depth and/or a penetration angle of at least one holding needle 202 is controllable. The holding needle device 201 is configured to introduce holding needles 202 into the fabric layers 111 for fixing. By means of the holding needle device 201, either from the effector side, from the worktable side or from an auxiliary system (for example auxiliary plate, needle tape), one or more needle-like pins or holding needles can be driven out of a magazine into or through the fabric layers 111 in order to fasten them to one another and/or to the effector 101. The holding needle device 201 comprises in particular a feeding device, for example a holding needle magazine, which is configured to feed holding needles for the holding needle device.

FIG. 3 shows a schematic illustration of a handling mechanism 120 with a suction surface 301 according to an exemplary embodiment of the present disclosure. In particular, the suction device 121 forms the suction surface 301 on which one of the fabric layers 111 or the fabric layer stack 112 can be placed. This surface 301 therefore also forms the effector contour 106. The suction surface 301 comprises a plurality of suction openings 302. In the case of a handling mechanism 120 based on negative pressure, sufficient force can be generated in the case of a small suction opening only with a high negative pressure in order to hold the fabric layers 111.

FIG. 4 shows a schematic illustration of a system for handling and processing fabric layers 111 with fixing elements 401 arranged on the effector 101 according to an exemplary embodiment. The fixing elements 401 can be arranged pivotably and extendably at the effector 101. The handling mechanism 120 can be arranged at one of the fixing elements 401, wherein the handling mechanism 120 is further configured to fix and convey the fabric layer stack 112 for handling to the joining unit 140, in particular within the effector contour 106.

The effector 101 can comprise a plurality of, e.g. five, fixing elements 401. A fixing element 401 comprises at least one handling mechanism 120, for example a suction device 121, a mechanical gripper, grippers with vacuum nozzles, a holding needle device 201 with holding needles 202, a fixing system with electrostatic attraction, fixing rollers, in particular opposing fixing rollers and/or clamps.

A plurality of fixing points with corresponding (identical or different) handling mechanisms 120 can be arranged at a carrier rod of a fixing element 401. The carrier rod can be fastened to the effector 101 in particular pivotably and/or translationally displaceably. Furthermore, the carrier rod can, for example, be extended and retracted telescopically in order to change its length. In addition, the carrier rod itself can comprise at least one joint, so that the carrier rod itself comprises two partial regions which can be pivoted relative to one another. An exact setting and adjustment of the gripping device of a fixing element 401 can thus be made possible. The adjustment of the effector contour 106 of the effector 101 can, for example, be enabled by integrated actuators (e.g. stepper motors with mechanical transmission to the fixing elements 401).

The fixing elements 401 are arranged at the effector 101 such that at least one fixing element 401 or all guide elements 401 comprise two degrees of freedom per arm in an x-y plane and in particular a further additional degree of freedom in the z-plane (for folding away inactive grippers).

The x-y plane is defined as that plane in which the fabric layer 111 is present when it is fixed by the fixing elements. In particular, the fabric layer 111 is spanned between the fixing elements. In this spanned state, the fabric layer 111 has a flat shape and thus lies within the x-y plane. The normal of the x-y plane forms the z-direction. In other words, the x-y plane forms the fabric plane and the thickness of the fabric is defined along the z-direction.

According to a further exemplary embodiment, the handling mechanism 120 is configured to detect a fabric layer 111 at fixing points at which the handling mechanism 120 fixes the fabric layer 111. The handling mechanism 120 is further configured such that the fixed fabric layer 111 can be spanned by moving the fixing points. Additionally or alternatively, the handling mechanism 120 is further configured to fix the fabric layer 111 at further fixing points within the effector contour 106 and/or to re-span it with the further fixing points. A fixing point can then, for example, be moved by moving the fixing elements 401 and a Spanning of the held fabric layers 111 can be enabled accordingly.

Furthermore, a data processing unit 402 is shown which is configured to provide fabric layer data relating in particular to fabric layer material and/or fabric layer geometry. The data processing unit 402 is further configured to provide processing data, in particular left/right position, alignment, unfolding and/or production quality of one of the fabric layers 111 or of the fabric layer stack 112. The data processing unit 402 is coupled to the control unit 105 for data exchange. In particular, the knowledge from the sensory evaluation as to whether the respective manipulation or handling was successful can be used with the control unit 105, in particular in conjunction with the data processing system 402.

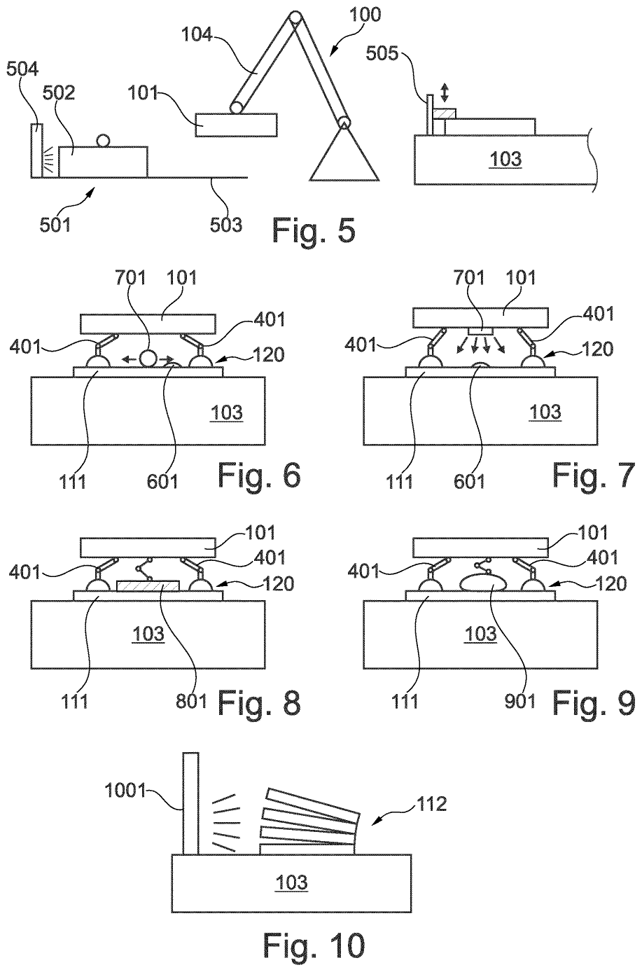

FIG. 5 shows a schematic illustration of a system with an effector exchange device 501 according to an exemplary embodiment. The effector 101 is configured to be exchangeable. The system can comprise an effector exchange device 501 which is configured to automatically couple and decouple an effector 101 from the handling robot 100. The effector exchange device 501 is in particular configured to automatically couple and decouple supply lines to the effector 101. The effector exchange device 501 is further configured to convey the effector 101 between a storage location 503 and the handling robot 100. The effector 101 can thus be deposited at a standing location and another effector 101 can be coupled to the handling robot 100. The required connections to resources (energy, compressed air, vacuum, data, control lines) are also connected and dust-tightness is ensured. The contour issue can thus be solved in the case of fabric pieces of different sizes.

The effector exchange device 501 is for example arranged at a storage location 503, at which a plurality of different effectors can be stored with different handling mechanisms. The handling robot 100 can place the effector 101 at a predetermined location of the effector exchange device 501 by moving its robot arm 104. The effector exchange device 501 can be arranged locally at the storage location 503 for receiving the effector 101. For example, an automatic coupling and decoupling can take place at the robot arm 104 in order to place the effector 101 at a desired location at the effector exchange device 501.

The system can in particular comprise an effector cleaning unit 504 at the storage location 503 in order to clean the effector 101. At the storage location 503, the unused effector 101 can be (automatically) cleaned with the effector cleaning unit 504. In particular, surfaces with a specific frictional resistance require regular cleaning in order to ensure the desired frictional effects. In addition, sensors, such as, for example, optical lenses of the optical sensor 131, or also parts of the suction device 121 or of the vacuum system can be cleaned with the effector cleaning unit 504.

Furthermore, the work table 103 comprises a hold-down device 505 which is configured to selectively fix the fabric layer 111 at the work table 103, in particular by means of electrostatic holding forces. The hold-down device 505 can press with a force against the work table 103/the work surface 102, which leads to a fixing of the two fabric layers 111 lying in between. Alternatively, the effector 101 can also allow compressed air to flow in between its underside and the fabric layers 111. This is particularly helpful when the effector 101 has to reposition itself so that it can quickly overcome the adhesive forces between the effector 101 and the first fabric layer 111.

FIG. 6 shows a schematic illustration of a system with a roller unit 601 for carrying out a smoothing action according to an exemplary embodiment. When a fold is detected by means of the monitoring device 130, such a smoothing action of the fabric layer 111 can be carried out. In order to carry out the smoothing action, the effector 101 is configured in particular such that the effector 101 supports the fabric layer 111 on a work table 103 and changes fixing points of the handling mechanism 120 with the fabric layer 111, so that a smoothing of the fabric layer 111 can be carried out. Additionally or alternatively, in order to carry out the smoothing action, the effector 101 can be configured in particular such that a repositioning and correspondingly a smoothing of the fabric layer 111 can be carried out by means of lifting and repositioning on a work table 103. Further, in order to carry out the smoothing action, the effector 101 can be configured in particular such that a shaking movement can be carried out by means of the effector 101 in order to achieve a smoothing of the fabric layer 111.

As shown in FIG. 6, in order to carry out the smoothing action, the effector 101 can comprise a roller unit 601, which is configured in particular such that the effector 101 supports the fabric layer 111 on a work table 103 and smooths the fabric layer 111 by means of the roller unit 601.

FIG. 7 shows a schematic illustration of a system with a blow-out unit 701 for carrying out a smoothing action according to an exemplary embodiment. In order to carry out the smoothing action, the effector 101 can comprise a blow-out unit 701 for blowing out compressed air in the direction of the fabric layer 111, which blow-out unit is configured in particular such that compressed air can be blown onto the surface of a fabric layer 111 in order to span the same for the reduction of folds.

FIG. 8 shows a schematic illustration of a system with a smoothing plate 801 for carrying out a smoothing action according to an exemplary embodiment. In order to carry out the smoothing action, the effector 101 can comprise a smoothing plate 801, in particular a heatable smoothing plate 801, and can be configured such that a smoothing can be carried out by means of pressing the smoothing plate 801 onto the fabric layer 111.

FIG. 9 shows a schematic illustration of a system with a punch 901 for carrying out a smoothing action according to an exemplary embodiment. In order to carry out the smoothing action, the effector 101 can comprise an elastic and/or inflatable punch 901 and can be configured such that the surface of the punch 901 can be enlarged by means of pressing the punch 901 onto the fabric layer 111 and thus a smoothing of the fabric layer 111 can be carried out.

FIG. 10 shows a schematic illustration of a system with a loosening unit 1001 for supporting a separation of fabric layers 111 according to an exemplary embodiment. The loosening unit 1001 is arranged at a work table 103 next to a fabric layer stack 112 and/or at the effector 101. In the illustrated embodiment, the loosening unit 1001 comprises a compressed air unit for laterally blowing compressed air into the fabric layer stack 112.

For example, the effector 101 can press on the fabric layer stack 112 and at the same time loosen the fabric layer stack 112 with compressed air and/or with a mechanical movement of the loosening unit 1001, which is mounted in a stationary manner at the work table 103. For example, the loosening unit 1001 can blow in compressed air, in particular laterally, over the cut edges of the fabric layer stack 112.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a restriction.

List of reference signs:

100 Handling robot
101 Effector
102 Work surface
103 Work table
104 Robot arm
105 Control unit
106 Effector contour
107 Feeding unit
111 Fabric layer
112 Fabric layer stack
113 Joining region
120 Handling mechanism
121 Suction device
130 Monitoring device
131 Optical sensor
132 Weight sensor
133 Distance sensor
140 Joining unit
201 Holding needle device
202 Holding needles
301 Suction surface
302 Suction opening
401 Fixing element
402 Data processing unit
403 Weight sensor Work table
501 Effector exchange device
502 Further effector
503 Storage location
504 Effector cleaning unit
505 Hold-down device
601 Roller unit
701 Blow-out unit
801 Smoothing plate
901 Punch
1001 Loosening unit

1-32. (canceled)

33. A system for handling and processing fabric layers, the system comprising:
a handling robot with an effector for handling fabric layers;
wherein the effector comprises a handling mechanism which is configured to receive and deposit at least one fabric layer,
wherein the handling mechanism comprises an effector contour, wherein the fabric layer can be fastened within the effector contour,
wherein the effector contour is smaller than an outer contour of the fabric layer,
wherein the handling mechanism is configured to singulate and receive at least one fabric layer individually from a fabric layer stack,
wherein the handling mechanism is further configured to deposit at least one singulated fabric layer in a flat manner on a work surface of a work table,
wherein the handling mechanism is further configured to span the fabric layer within the effector contour in a fold-free manner; and
a monitoring device, which is configured to monitor the singulation of the at least one fabric layer from the fabric layer stack.

34. The system according to claim 33,
wherein the monitoring device comprises an optical sensor,
wherein the optical sensor is configured to detect a singulated fabric layer, which is received by the handling mechanism.

35. The system according to claim 33, comprising at least one of the following:
wherein the monitoring device comprises a weight sensor,
wherein the weight sensor is arranged at the effector such that a weight of the fabric layer received by the handling mechanism is measurable, and
wherein the weight sensor is configured such that a weight change of the fabric layer stack is measurable before and after the singulation of a fabric layer.

36. The system according to claim 33,
wherein the monitoring device comprises at least one of a touch sensor and a distance sensor to determine the presence of a singulated fabric layer at the handling mechanism.

37. The system according to claim 33,
wherein the handling mechanism comprises a suction device which is configured to singulate and receive a fabric layer from the fabric layer stack by means of negative pressure,
wherein the air flow is indicative of whether the suction device holds a fabric layer, whether multiple fabric layers are held or whether no fabric layer is received.

38. The system according to claim 37,
wherein the suction device forms a suction surface on which one of the fabric layers or the fabric layer stack can be placed,
wherein the suction surface comprises a plurality of suction openings.

39. The system according to claim 38,
wherein the suction openings are formed with a diameter of less than 20 mm.

40. The system according to claim 33,
wherein the monitoring device comprises a sensor for measuring an electromagnetic field,
wherein the electromagnetic field strength is indicative of whether the handling mechanism holds a fabric layer, whether multiple fabric layers are held or whether no fabric layer is received.

41. The system according to claim 33,
wherein the handling mechanism is configured to detect a fabric layer at fixing points at which the handling mechanism fixes the fabric layer,
comprising at least one of:
wherein the handling mechanism is further configured such that the fixed fabric layer can be spanned by moving the fixing points, and
wherein the handling mechanism is further configured to at least one of fix the fabric layer at further fixing points within the effector contour and to re-span it with the further fixing points.

42. The system according to claim 33,
wherein the handling mechanism is further configured such that fabric layers can be received individually from two spaced fabric layer stacks.

43. The system according to claim 33,
wherein the effector comprises at least one fixing element at which the handling mechanism is formed,
wherein the handling mechanism is further configured to fix and convey the fabric layer stack for handling to a joining unit,
wherein the handling mechanism is selected from the group consisting of at least one of grippers, suction units, clamps, regions with increased friction and electrostatic attraction, holding needles, rollers, freezing grippers, and Bernoulli grippers.

44. The system according to claim 33,
wherein the handling mechanism is controllable such that different gripping intensities for fixing one of the fabric layers or a plurality of fabric layers are controllable.

45. The system according to claim 33, comprising at least one of the following features:
wherein the effector comprises at least two handling mechanisms which are selectively controllable for fixing one of the fabric layers or the fabric layer stack,
wherein the at least two handling mechanisms are activatable and controllable depending on a sensor value, depending on at least one of a manipulation step and a joining step;
wherein the monitoring device generates monitoring data which describe at least one of the number, the orientation and the characteristic of the fabric layer which is fixed to the handling mechanism,
wherein the handling mechanism is controllable based on the monitoring data.

46. The system according to claim 33,
wherein the handling mechanism comprises a holding needle device with holding needles which is configured such that at least one of a penetration depth and a penetration angle of at least one holding needle is controllable.

47. The system according to claim 46,
wherein the holding needles comprise a diameter of less than 1300 micrometers.

48. The system according to claim 33, comprising at least one of the following features:
wherein the handling mechanism comprises a support element for supporting the at least one fabric layer to be conveyed,
wherein the handling mechanism is configured such that the fabric layer is liftable and the support element is conveyable below the fixed fabric layer;
wherein the handling mechanism is configured such that a joining region of the fabric layer, at which a joining step of a joining unit is performable, forms a protrusion with respect to the effector contour of more than 0.5 cm;
further comprising
the work table with the work surface,
wherein the work table comprises a hold-down device which is configured to selectively fix the fabric layer at the work table;
wherein the monitoring device comprises an air humidity sensor,
wherein the handling mechanism is controllable based on the measured air humidity,
wherein the system comprises an air humidifying device for adjusting the air humidity,
wherein the air humidifying device is controllable based on the measured air humidity.

49. The system according to claim 33, comprising at least one of the following features:
wherein the monitoring device is configured to detect incorrect grips or incorrect placements of the fabric layer at the handling mechanism,
wherein the handling mechanism is configured to deposit and re-grip the fabric layer upon detection of incorrect grips or incorrect placements;
wherein the effector is configured to be exchangeable,
wherein the system comprises an effector exchange device which is configured to automatically couple and decouple an effector from the handling robot,
wherein the effector exchange device is configured to automatically couple and decouple supply lines to the effector,
wherein the effector exchange device is configured to convey the effector between a storage location and the handling robot,
wherein the system comprises an effector cleaning unit at the storage location in order to clean the effector;
wherein the effector is configured to press down the fabric layer on a work surface of a work table;
wherein the effector is configured to carry out a smoothing action of the fabric layer,
wherein in order to carry out the smoothing action, the effector is configured such that the effector supports the fabric layer on a work table and changes fixing points of the handling mechanism with the fabric layer, so that a smoothing of the fabric layer can be carried out,
wherein in order to carry out the smoothing action, the effector comprises a roller unit,
wherein in order to carry out the smoothing action, the effector is configured such that a repositioning and correspondingly a smoothing of the fabric layer can be carried out by means of lifting and repositioning on a work table,
wherein in order to carry out the smoothing action, the effector is configured such that a shaking movement can be carried out by means of the effector in order to achieve a smoothing of the fabric layer,
wherein in order to carry out the smoothing action, the effector comprises a blow-out unit for blowing out compressed air in the direction of the fabric layer,
comprising at least one of:
wherein in order to carry out the smoothing action, the effector comprises a smoothing plate and is configured such that a smoothing can be carried out by means of pressing the smoothing plate onto the fabric layer, and
wherein in order to carry out the smoothing action, the effector comprises at least one of an elastic punch and an inflatable punch and is configured such that the surface of the punch can be enlarged by means of pressing the punch onto the fabric layer and thus a smoothing of the fabric layer can be carried out;
further comprising
a loosening unit for loosening the fabric layer stack,
wherein the loosening unit is arranged at least one of on a work table next to a fabric layer stack and at the effector,
wherein the loosening unit comprises at least one of a shaking unit for shaking the fabric layer stack, a compressed air unit for laterally blowing compressed air into the fabric layer stack and an elastostatic unit for statically charging the fabric layers of the fabric layer stack.

50. The system according to claim 33, comprising at least one of the following features:
further comprising
a feeding unit, which is configured to convey a fabric layer stack,
wherein the feeding unit is configured to convey a fabric layer stack from a storage area to a work table, at which fabric layers of the fabric layer stack can be singulated by means of the handling mechanism of the effector;
wherein the effector comprises a contact surface, on which one of the fabric layers or the fabric layer stack can be placed within the effector contour;
further comprising
a data processing unit which is configured to provide fabric layer data,
wherein the data processing unit is further configured to provide processing data of one of the fabric layers or of the fabric layer stack;
wherein the effector comprises at least two handling mechanisms,
wherein at least one of:
the two handling mechanisms comprise different handling mechanisms and
apply different gripping intensities on the left and the right side of one of the fabric layers or of the fabric layer stack;
wherein at least one of the fabric layers and the fabric layer stack represent an item of clothing or parts thereof.

51. A method for handling and processing fabric layers, the method comprising:
receiving and depositing at least one fabric layer by means of a handling mechanism of an effector of a handling robot,
wherein the handling mechanism comprises an effector contour, wherein the fabric layer can be fastened within the effector contour,
wherein the effector contour is smaller than an outer contour of the fabric layer,
wherein the handling mechanism is configured to singulate and receive at least one fabric layer individually from a fabric layer stack,
wherein the handling mechanism is further configured to deposit at least one singulated fabric layer in a flat manner on a work surface of a work table,
spanning the fabric layer within the effector contour in a fold-free manner, and
monitoring the singulation of the at least one fabric layer from the fabric layer stack by means of a monitoring device.

52. The method according to claim 51,
wherein the effector is configured to wait more than 1 second until the next singulation from the same fabric layer stack between two singulations, in which respectively a fabric layer is singulated from the fabric layer stack by the handling mechanism.
